(19) United States
(12) Patent Application Publication
(10) Pub. No.: US 2010/0076576 A1
(43) Pub. Date: Mar. 25, 2010

(54) SYSTEMS, METHODS, AND DEVICES FOR PROVIDING BROADCAST MEDIA FROM A SELECTED SOURCE

(75) Inventors: Jeffery Lee, Sunnyvale, CA (US); Michael Ignazio Ingrassia, JR., San Jose, CA (US); Ryan Perry, San Francisco, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/237,247

(22) Filed: Sep. 24, 2008

(51) Int. Cl. G06F 17/00

(52) U.S. Cl. 700/94

(57) ABSTRACT

A media device including a broadcast receiver that receives media from a broadcast source via a broadcast radio signal and a radio signal sensor that measures a signal characteristic of the received broadcast radio signal. The media device also includes a data transceiver that i) requests and retrieves a network address of a media server which provides the media via a network signal from a data network, ii) establishes a data connection with the media server, and iii) receives the media via the network signal from the media server. The media device further includes a selector that i) selects the broadcast radio signal when the signal characteristic satisfies a selection standard and ii) selecting the network signal when the signal characteristic does not satisfy the selection standard. The media device also includes a user interface that provides at least one of an audio and visual output based on the selected signal.

### REFERENCE TO RELATED APPLICATIONS

This application is related to the following: U.S. patent application Ser. No. ______, filed on Sep. 24, 2008, having Attorney Docket No. 104677-0302-101 (P6710US1), and entitled “Media Device with Enhanced Data Retrieval Feature”; U.S. patent application Ser. No. ______, filed on Sep. 24, 2008, having Attorney Docket No. 104677-0299-101 (P6574US1), and entitled “Systems, Methods, and Devices for Retrieving Local Broadcast Source Presets”; and U.S. patent application Ser. No. ______, filed on Sep. 24, 2008, having Attorney Docket No. 104677-0300-101 (P6575US1), and entitled “Systems, Methods, and Devices for Associating a Contact Identifier with a Broadcast Source.” The entire contents of the above-referenced applications are incorporated herein by reference.

### BACKGROUND

This invention relates to media devices having a broadcast receiver capable of receiving broadcast media via a first wireless interface and an alternative receiver for receiving the media via a second wireless interface.

Traditional media devices, e.g., an MP3 player, typically connect with a headset to enable a user to listen to music. Other media devices may include a display that displays videos. Many types of media devices are portable and have compact form factors to enable efficient handling and use by a user. Certain media devices include a radio broadcast receiver capable of receiving amplitude modulated (AM), frequency modulated (FM), or satellite broadcast media. The media can typically include a song, video, news program, or radio show. Certain media devices, e.g., cellular telephones, include wireless transceivers capable of exchanging data with a public land mobile network (PLMN) or wireless data network that may be linked with the Internet or other data networks. Other media devices are capable of interfacing with personal area networks (PAN), wireless local area networks (WLAN), satellite data networks (SAN), and other data networks including, for example, Wi-fi (802.x) networks.

In addition to providing broadcast media (e.g., songs, video, television programs, and radio shows), certain broadcast media sources can supplement the broadcast media with broadcast media data. The broadcast media data can include media metadata (e.g., information about a particular song) or data about the broadcast source (e.g., the name of the broadcasting radio station).

The Radio Data System (RDS) is a communications standard developed by the European Broadcasting Union (EBU) that enables the transmission of small amounts of broadcast media data using FM radio broadcasts. RDS can send various types of broadcast media data including: time, track title, track artist, and station identification. RDS has been used in Europe and South America since the early 1990s.

The Radio Broadcast Data System (RBDS) is the name for the North American version of RDS, and is also often referred to simply as “RDS.” The North American and European versions are nearly identical. Both RDS versions use a 57 kHz sub carrier to carry broadcast media data at 1187.5 bits per second.

In addition to broadcasting media via traditional radio broadcasting, certain radio broadcast providers are now providing streaming versions of their broadcast media via data servers connected to the Internet. Thus, users of computer systems connected to the Internet are able to listen to the broadcast media via the Internet as opposed to via a radio broadcast.

One problem with using existing broadcast radio systems is that the broadcast signal is typically limited to a geographic area within the range or vicinity of the broadcast radio source. As a radio receiver moves out of range of the broadcast source, the broadcast signal strength decreases and degrades to a signal strength or quality that is inadequate for reception. Also, a broadcast signal may be susceptible to dead zones, obstructions, or interference that make reception inadequate. Accordingly, there is a need to enable a media device to receive media when the broadcast signal strength or quality fades or become inadequate for reception.

### SUMMARY

The invention, in various embodiments, addresses deficiencies in the prior art by providing systems, methods and devices that enable a media device to receive broadcast media even when the broadcast signal strength or quality becomes inadequate for proper reception.

In one aspect, a media device includes a broadcast receiver that receives media from a broadcast source via a broadcast radio signal and a radio signal sensor that measures a signal characteristic of the received broadcast radio signal. The media device also includes a data transceiver for i) requesting and retrieving a network address of a media server providing the media via a network signal from a data network, ii) establishing a data connection with the media server, and iii) receiving the media via the network signal from the media server. The media device further includes a selector that selects the broadcast radio signal when the signal characteristic satisfies a selection standard and selects the network signal when the signal characteristic does not satisfy the selection standard. The media device also includes a user interface that provides an audio and/or visual output based on the selected signal.

In one configuration, the broadcast radio signal includes a FM and/or AM radio signal. The media may include a song and/or music. The radio signal sensor may include a received signal strength sensor, e.g., RSSI detector. The signal characteristic may include the received strength of the broadcast radio signal. The selection standard may include a signal strength threshold level. In one feature, the selection standard is satisfied when the received signal strength of the broadcast radio signal is equal to or greater than the threshold level.

The network address may include an IP address, a URL, a sequence number, and/or a data stream identifier. The data network may include the Internet. The media server may include a broadcast source server and/or a clearinghouse server. The media may include a video, an image, audio, audio file, multimedia, movie, and/or television data.

In one configuration, the media device includes a location sensor that determines the geographic location of the media device. The location sensor may include a GPS receiver, a wireless doppler sensor, a wireless triangulation sensor, a cellular telephone network system identifier detector, and/or a wireless network system identifier detector.

In one feature, the selector identifies the broadcast source by identifying the frequency of the broadcast radio signal and/or the location of the media device. The data transceiver may request the network address of the media server based, at least in part, on the identified broadcast source.

In another configuration, the selector includes a data switch that selects one of the broadcast radio signal and the network signal. The selector may also include a processor that determines when the signal characteristic satisfies the selection standard or does not satisfy the selection standard and controls the selection by the data switch based on the determination.

The data connection may include a circuit-switched and/or packet-switched data connection. The data transceiver may initiate the establishment of the data connection with the media server when the signal characteristic does not satisfy the selection standard. The media device may include a synchronizer that synchronizes the selecting between the broadcast radio signal and the network signal to minimize the likelihood that a user becomes aware of a switching of the media source between the broadcast media signal and network signal.

In another aspect, the media device includes a data store that stores a list of data network addresses associated with a plurality of media servers where at least one network address is associated with at least one media server. Instead of or in addition to querying a media server for the network address a network signal, the media device may query its own data store to obtain a network address of a media server that provides the media via a network signal.

In further aspect, a media distribution server includes a first interface that receives media from a broadcast source via a first network signal of a data network. The media is associated with a broadcast radio signal being broadcast by the broadcast source. The server includes a second interface that i) receives a request from a media device to receive the media where the request from the media device is in response to a signal characteristic of the broadcast radio signal of the media as received by the media device and ii) provides the media to the media device via a second network signal. The server may include a broadcast source server and/or a clearinghouse server.

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a perspective view of a media device according to an illustrative embodiment of the invention;

FIG. 2 is a view of a media device according to an illustrative embodiment of the invention;

FIG. 3 is a communications topology including a media device according to an illustrative embodiment of the invention;

FIG. 4 shows a simplified functional block diagram of a media device according to an illustrative embodiment of the invention;

FIG. 5 shows a diagram of a distribution system for media and media data according to an illustrative embodiment of the invention;

FIG. 6 shows a diagram of a public land mobile network (PLMN) data distribution system according to an illustrative embodiment of the invention;

FIG. 7 shows a diagram of a wireless access network including an access point according to an illustrative embodiment of the invention;

FIG. 8 is a diagram of a computer processing environment including various applications or routines running within a media device according to an illustrative embodiment of the invention;

FIG. 9 includes a database and/or list associating broadcast sources with broadcast source media server network addresses according to an illustrative embodiment of the invention; and

FIG. 10 is a flow diagram of a process for transferring the reception of media from a broadcast signal via a first wireless interface to an alternative signal via a second wireless interface according to an illustrative embodiment of the invention.

### DESCRIPTION OF THE INVENTION

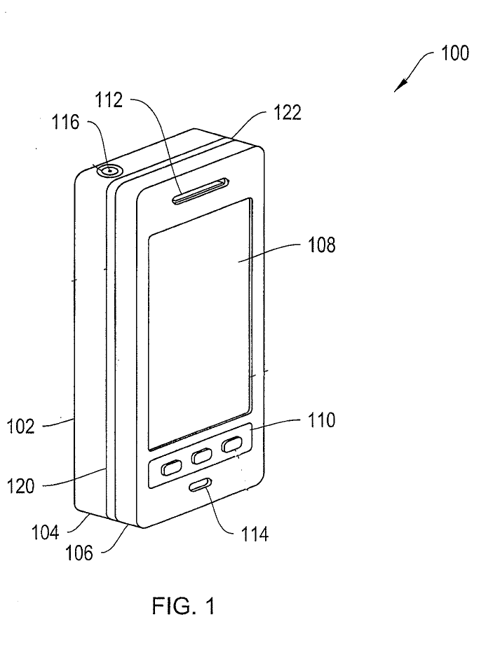

FIG. 1 is a perspective view of a media device 100 according to an illustrative embodiment of the invention. The device 100 includes a housing 102, a first housing portion 104, a second housing portion 106, a display 108, a keypad 110, a speaker housing aperture 112, a microphone housing aperture 114, a headphone jack 116, and frame sidewall 122. In certain embodiments, the frame sidewall 122 is the exposed portion of a frame residing within or adjacent to the housing 102 that provides structural support for the media device 100 and various internal components.

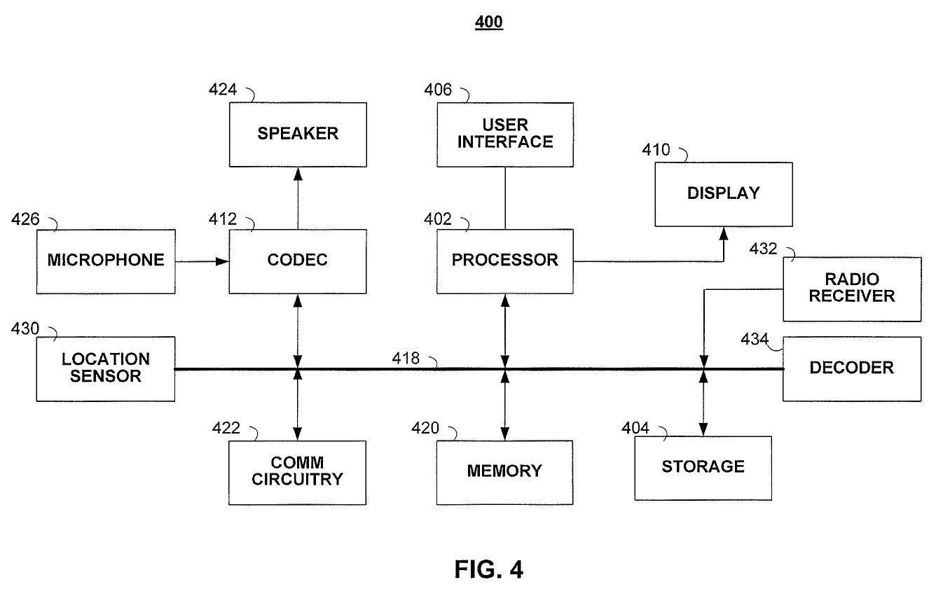

In one embodiment, the housing 102 includes a first housing portion 104 and a second housing portion 106 that are fastened together and/or to the frame sidewall 122 to encase various components of the media device 100. The housing 102 and its housing portions 104 and 106 may include polymer-based materials that are formed by, for example, injection molding to define the form factor of the media device 100. In one embodiment, the housing 102 surrounds and/or supports internal components such as, for example, a display 108, one or more circuit boards having integrated circuit components, internal radio frequency (RF) circuitry, an internal antenna, a speaker, a microphone, a hard drive, a processor, and other components. Further details regarding certain internal components are discussed herein with respect to FIG. 4. The housing 102 provides for mounting of a display 108, keypad 110, external jack 116, data connectors, or other external interface elements. The housing 102 may include one or more housing apertures 112 to facilitate delivery of sound, including voice and music, to a user from a speaker within the housing 102. The housing 102 may include one or more housing apertures 114 to facilitate the reception of sounds, such as voice, for an internal microphone from a device user.

Personal computing devices and/or media devices of this type may include a touchscreen control, such as a Pronto made available by Royal Philips Electronics of the Netherlands or a GPS receiver made available by Garmin International, Inc. of Olathe, Kans. In certain embodiments, the display 108 includes a graphical user interface (GUI) to enable a user to interact with the device 100. The personal computing device 100 may also include an image sensor such as a camera capable of capturing photographic images and/or video images.

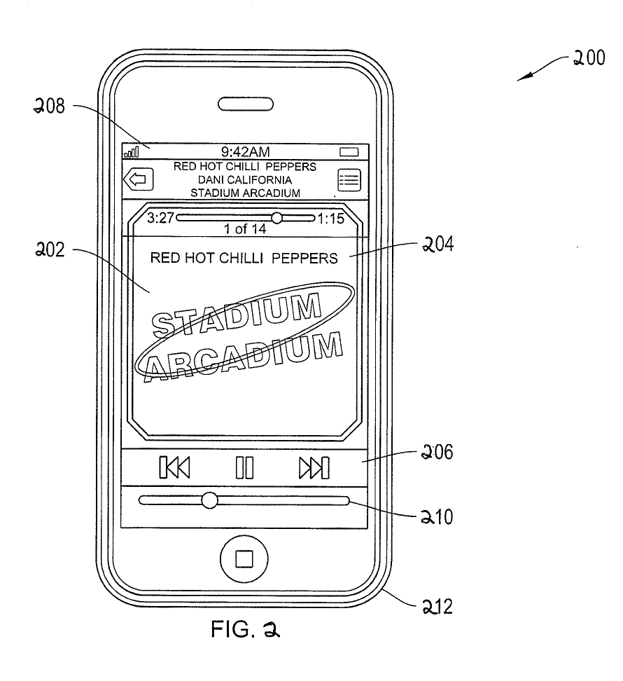

FIG. 2 is a view of another personal media device 200 according to an illustrative embodiment of the invention. The media device 200 includes a display 202 showing a status bar 208 and video image 204, which may include, for example, a music video, a movie, video clip, or like video images. In one embodiment, a GUI of the display 202 includes an interface 206 that enables the media device 200 user to play, pause, fast forward, reverse, or monitor, via a slider 210, the progress of the video displayed on the display 202 or audio being played by the media device 200. The media device 200 includes a housing base 212.

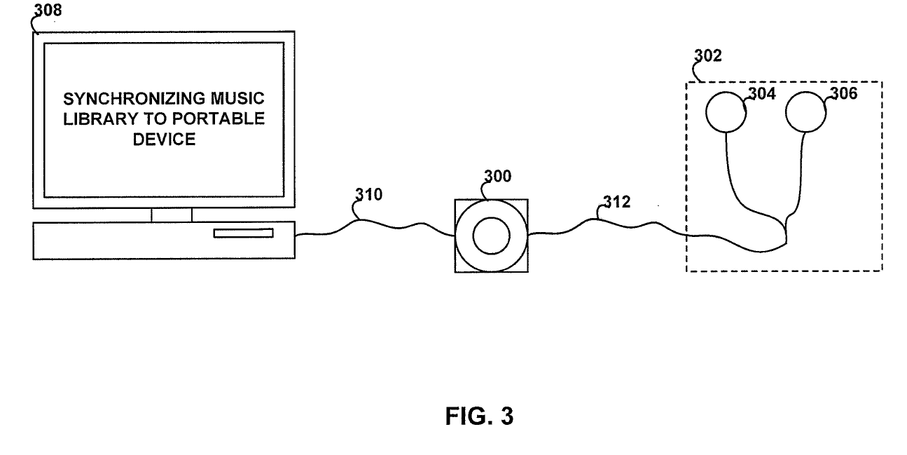

FIG. 3 shows a communications topology including a computer 308, media device 300, and a headset 302. Media device 300 may communicate with computer 308 via communications channel 310. Media device 300 may communicate with the headset 302 via communications channel 312. In one embodiment, communications channel 312 is a wired communication channel. Alternatively, the communications channel 312 may be wireless.

Media device 300 may take any form. For example, media device 300 may be a portable media player such as a portable music player. Media device 300 may also include, for example, a mobile telephone that may play downloaded media. Media may be downloaded directly to the media device 300 or may be downloaded to computer 308 and transferred to the media device 300 via communications channel 310.

The media device 300 may include a wireless communications device such as a cellular telephone, satellite telephone, cordless telephone, personal digital assistant (PDA), pager, portable computer, or any other device capable of wireless communications. In fact, FIG. 2 shows an exemplary cellular telephone version of a broad category of media device 300. The media device 300 may be compact, portable, mobile, personal, and/or transportable.

The media device 300 may also be integrated within the packaging of other devices or structures such as a vehicle, video game system, appliance, clothing, helmet, glasses, wearable apparel, stereo system, computer system, entertainment system, or other portable devices. In certain embodiments, the media device 300 may be docked or connected to a wireless (e.g., a wi-fi docking system) and/or radio enabling accessory system (e.g., AM/FM or satellite radio receiver) that provides the media device 300 with short-range communicating functionality and/or radio reception capability. Alternative types of media devices 300 may include, for example, a media player such as an iPod®, iPod® Nano, iPod® Shuffle, or Apple® iphone available by Apple Inc., of Cupertino, Calif., pocket-sized personal computers such as an iPAQ® Pocket PC available by Hewlett Packard Inc., of Palo Alto, Calif. and any other device capable of communicating wirelessly (with or without the aid of a wireless enabling accessory system).

In certain embodiments, the media device 300 may synchronize with, for example, a remote computing system or server, e.g., computer 308, to receive media (using either wireless or wireline communications paths).

Wireless syncing enables the media device 300 to transmit and receive media and data without requiring a wired connection. Media may include, without limitation, sound or audio files, music, video, multi-media, and digital data, in streaming and/or discrete (e.g., files and packets) formats.

During synchronization, a host system, e.g., device 308, may provide media to a client system or software application embedded within the media device 300. In certain embodiments, media and/or data is “downloaded” to the media device 300. In other embodiments, the media device 300 is capable of uploading media to a remote host or other client system.

The headset 302 may be utilized to provide an audio functionality associated with media device 300. The headset 302 may include speakers 304 and 306 as well as a microphone.

FIG. 4 shows a simplified functional block diagram of a media device 400 according to an illustrative embodiment of the invention. The block diagram provides a generalized block diagram of a computer system such as may be employed, without limitation, by the media devices 100, 200, and 300. The media device 400 may include a processor 402, storage device 404, user interface 406, display 610, CODEC 612, bus 618, memory 620, communications circuitry 622, a speaker or transducer 624, a microphone 426, a location sensor 430, a radio receiver 432, a radio receiver decoder 434, a speaker 424, and communications circuitry to facilitate communications with a headset 302, other media device, or other system via a communications network. Processor 402 may control the operation of many functions and other circuitry included in media device 400. Processor 402 may drive display 410 and may receive user inputs from the user interface 406.

Storage device 404 may store media (e.g., music and video files), software (e.g., for implanting functions on device 400), preference information (e.g., media playback preferences), lifestyle information (e.g., food preferences), personal information (e.g., information obtained by exercise monitoring equipment), transaction information (e.g., information such as credit card information), word processing information, personal productivity information, wireless connection information (e.g., information that may enable media device to establish wireless communication with another device), subscription information (e.g., information that keeps tracks of podcasts or television shows or other media that a user subscribes to), radio station broadcast source information, and any other suitable data. Storage device 404 may include one more storage mediums, including for example, a hard-drive, permanent memory such as ROM, semi-permanent memory such as RAM, or cache.

Memory 420 may include one or more different types of memory which may be used for performing device functions. For example, memory 420 may include cache, ROM, and/or RAM. Bus 418 may provide a data transfer path for transferring data to, from, or between at least storage device 404, memory 420, and processor 402. Coder/decoder (CODEC) 412 may be included to convert digital audio signals into an analog signals for driving the speaker 424 to produce sound including voice, music, and other like audio. The CODEC 412 may also convert audio inputs from the microphone 426 into digital audio signals. The CODEC 412 may include a video CODEC for processing digital and/or analog video signals.

User interface 408 may allow a user to interact with the media device 400. For example, the user interface 408 can take a variety of forms, such as a button, keypad, dial, a click wheel, or a touch screen.

Communications circuitry 422 may include circuitry for wireless communication (e.g., short-range and/or long range communication). For example, the wireless communication circuitry may be Wi-Fi enabling circuitry that permits wireless communication according to one of the 802.1x standards. Other wireless network protocols standards could also be used, either in alternative to the identified protocols or in addition to the identified protocol. Other network standards may include Bluetooth, the Global System for Mobile Communications (GSM), code division multiple access (CDMA), and long-term evolution (LTE) based wireless protocols. Communications circuitry 422 may also include circuitry that enables the media device 400 to be electrically coupled to another device (e.g., a computer or an accessory device) and communicate with that other device.

In one embodiment, the media device 400 may be a portable computing device dedicated to processing media such as audio and video. For example, the media device 400 may be a media device such as media player (e.g., MP3 player), a game player, a remote controller, a portable communication device, a remote ordering interface, an audio tour player, or other suitable media device. The media device 400 may be battery-operated and highly portable so as to allow a user to listen to music, play games or video, record video or take pictures, communicate with others, and/or control other devices. In addition, the media device 400 may be sized such that it fits relatively easily into a pocket or hand of the user. By being handheld, the media device 400 (or media devices 100, 200, and 300) is relatively small and easily handled and utilized by its user and thus may be taken practically anywhere the user travels.

The media device 400 may employ a location sensor 430 to enable the media device to determine its geographic location in support of location-based services and other services. The location sensor 430 may include a global position system (GPS) receiver. The location sensor 430 may include one or more radio receivers that perform radio doppler and/or triangulation sensing to determine the media device 400 location. In certain embodiments, the location sensor 430 may be integrated with the communications circuitry 422. In one embodiment, the location sensor 430 may include a data decoder such as decoder 434 that decodes a source identifier broadcast by a radio source (e.g., radio station identifier or cellular network system identifier (SID)).

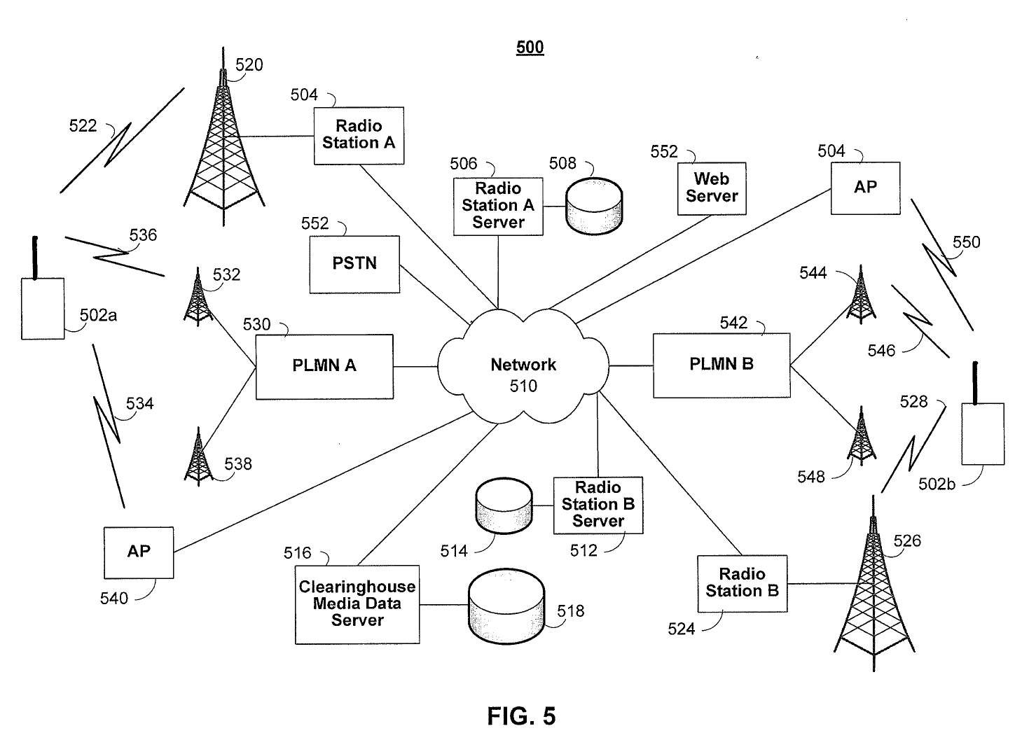

FIG. 5 shows a diagram of a media distribution system 500 according to an illustrative embodiment of the invention. The media distribution system 500 includes a media device 502, a broadcast radio station 504, a broadcast radio station 524, a public land mobile network (PLMN) 530, a PLMN 542, an access point (AP) 540, and AP 504, a data network 510, a public switched telephone network (PSTN) 552, and a clearinghouse server 516. The network 510 may include the Internet. The radio station 504 may include a radio station tower 520 that facilitates the broadcast of a broadcast radio signal 522 to a plurality of media devices including media device 502. Also, the radio station 524 may include a radio station tower 526 that facilitates the broadcast of a broadcast radio signal 528 to a plurality of media devices including media device 502.

The broadcast radio signal may be, without limitation, frequency modulated (FM) or amplitude modulated (AM). The interfaces 522 and 528 may operate in an AM frequency band of about 500-1500 kHz. The interfaces 522 and 528 may operate in an FM and/or television frequency band of about 54-1600 MHz. The interfaces 522 and 528 may operate and any number of frequency bands such as, for example, a satellite frequency band. The radio station 504 may be associated with a radio station server 506 that includes a database 508 for storing media and/or media data. The radio station 524 may be associated with a radio station server 512 that includes a database 514 for storing media and/or media data.

The PLMNs 530 and 542 may include a cellular telephone network. The PLMNs 530 and 542 may utilize a plurality of cellular radio towers 532, 538, 544, and 548 respectively. The media device 502 may exchange data and other communications with the PLMN 530 and/or 542 via a wireless communications channel 536 and/or 546 respectively. The media device 502 may exchange data and other communications with the AP 540 and/or AP 504 via a wireless communications channel 534 and 550 respectively. The clearinghouse media data server 516 may include a database 518 for storing media and/or media data.

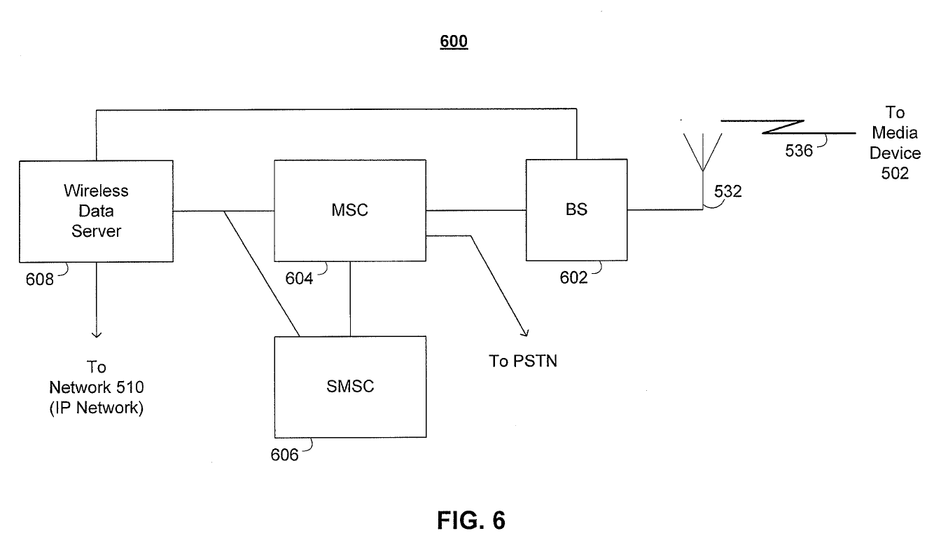

FIG. 6 shows a diagram of a public land mobile network (PLMN) 600 according to an illustrative embodiment of the invention. A PLMN may include a wireless telecommunications network and/or a cellular telephone network such as a Global System for Mobile communications (GSM), cdma2000 system, ANSI-136 TDMA system, LTE, and like wireless communications networks.

These networks may also provide data communications services such as Evolution-data only (EV-DO), General Packet Radio Service (GPRS), wireless application protocol (WAP), cellular digital packet data (CDPD), and like wireless data services.

PLMN networks are generally referred to as cellular networks because they employ a frequency re-use architecture in which wireless access channels are grouped into geographically-located cells and sectors. The size of each cell depends on the output power of the network base station (BS) transceiver, e.g., BS 602, associated with each cellular tower 532 and cell. Each access channel uses a certain frequency band in one geographic cell that is re-used in another cell, geographically separated from the first cell, by another access channel where the likelihood of interference is minimized.

These networks also use a centralized switch or server such as the mobile switching center (MSC) 604 to enable a wireless device to move from cell to cell while maintaining a persistent data connection. In the United States, cellular and Personal Communications Service (PCS) networks operate in the licensed commercial 800-900 Mhz and 1900-2100 Mhz ranges. Access data channels, however, may be bandwidth limited to 30 khz, 200 khz, or 1.24 Mhz depending on the wireless air interface standard used.

PLMN networks primarily provide voice communications while also providing relatively low rate data communications (e.g., 9.6-140 kbps). PLMN networks such as the Global System for Mobile Communications (GSM) and cdma2000 provide a Short Message Service (SMS) that enables telephone users to send relatively short, e.g., about 160 bytes, messages to other cellular telephones or to traditional electronic mail (e-mail) accounts within land-based IP networks.

A Short Message Server Center (SMSC) 606 typically coordinates with the MSC 604 to distribute SMS messages to cellular telephones and/or media devices 502. The SMSC may also interface with a wireless data server 608 to send SMS messages with destination addresses, e.g., e-mail addresses, external to the PLMN 600. The SMSC may include a mail server and/or other functionality to convert SMS messages to the proper e-mail format if necessary. Alternatively, the wireless data server may include a mail server such as a POP and/or Exchange server to facilitate the delivery of e-mail messages to and from the PLMN 600.

SMS messages may be transmitted over the air interface 120 via the traffic and/or control channels of the PLMN 600 network. While SMS messages are typically limited to about 160 bytes in length, longer text messages may be sent to or received by a media device 502. This may be performed by breaking a larger message into multiple SMS messages for delivery and then re-assembling the multiple SMS messages into the original message upon receipt. Multimedia message services (MMS) may also be employed having messages that include text, video, pictures, and audio.

Recently, PLMN providers have launched higher bandwidth data networks such as cdma2000 Evolution Data Only (EVDO) networks that provide up to 2 Mbps and Third Generation GSM (3GSM) networks that provide approximately 300 kbps data rates. These higher rate data services may employ point-to-point (PPP), simple IP and/or mobile IP (MIP) protocols to more efficiently interface with traditional IP networks such as network 510 and/or the Internet. The wireless data server 608 may function as a cdma2000 and/or GPRS Packet Data Server Node (PDSN), MIP Home Agent, MIP Foreign agent, wireless data gateway, and like systems to facilitate data communications with an external data network such as the network 510.

Using circuit-switched and/or packet-switched data services, the PLMN 600, 530, and 542 enables a media device 502 to act like a network interface to another data network such as the Internet. Thus, media device 502 may employ any of the applications and features of a standard workstation and/or home personal computer, subject to the processing speed, power, and memory constraints of a compact and mobile device. For example, the media device 502 may utilize a WWW browser employing HTML, WML, XML, and like markup languages to facilitate access to a remote web server, e.g., server 552, 506, 512, and/or 516, via the network 510. The media device 502 may utilize certain applications that enable the exchange of data with remote data servers connected to the network 510. Data may be transported to and from the network 510 via the wireless data server 608. In these instances, the wireless data server 608 exchanges data with the BS 602. The BS 602, in turn, transmits data to and/or receives data from the media device 502 via one or more data traffic channels on the air interface 536 or 546.

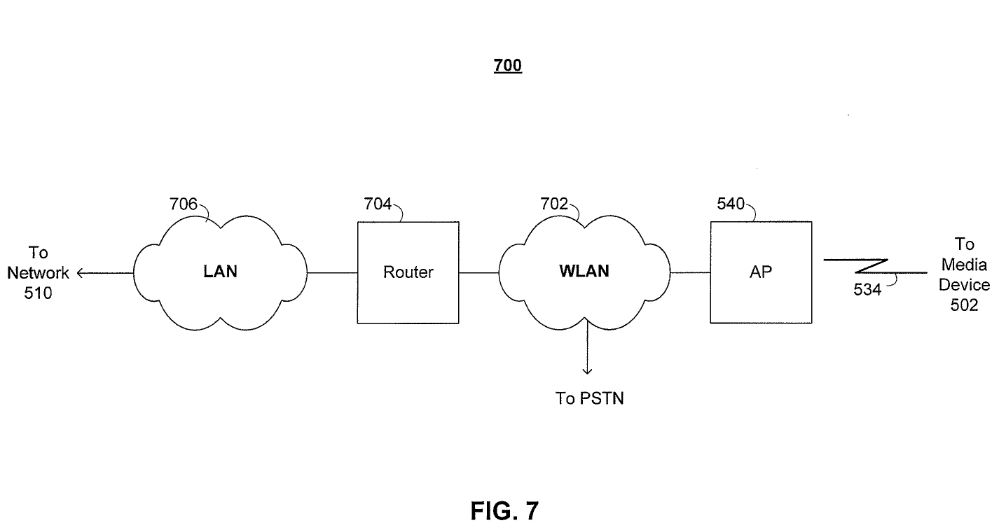

FIG. 7 shows a diagram of a wireless access network 700 including an access point (AP) 540 according to an illustrative embodiment of the invention. A wireless access network may include any wireless network that facilitates communications from one communications device to another or to another network such as the Internet. Typical wireless access networks include 802.11, WiFi, WiMAX, Bluetooth, proprietary wireless LANs, wide area wireless networks, and like wireless access networks.

The wireless access network 700 includes an AP 540, a wireless LAN (WLAN) 702, router 704, and local area network (LAN) 706. The LAN may be connected to network 510 via one or more data networks. The WLAN 702 may be connected to the PSTN 552 via one or more network interfaces. The AP 540 may connect with one or more media devices 502. WLAN networks, such as WLAN 702, employ wireless APs 540 to communicate with multiple wireless devices, e.g., media device 502, simultaneously via a set of wireless access channels.

While the wireless access network 700 may not support SMS messaging as with the PLMN 600, the wireless access network 700 is capable of supporting relatively high data rate communications between a media device 502 and the network 510. Furthermore, the wireless access network 700 can support higher layer protocols such as TCP/IP, HTTP, and UDP, which enable the use of a web browser and other applications at the media device 502.

Returning to FIG. 5, in operation, the media device 502 may move from one geographic location in the vicinity of certain wireless communications infrastructure elements to another geographic location in the vicinity of other wireless communications infrastructure elements. For example, FIG. 5 refers to media device 502 as media device 502a while the device is in the vicinity of radio station 504, but then refers to media device 502 as media device 502b when the device is in the vicinity of radio station 524. In other embodiments, the terms 502a and 502b can refer to different media devices.

As discussed previously, a media device 502 may include a broadcast radio receiver, e.g., radio receiver 432, that enables the media device 502 to receive media from a plurality of radio stations, e.g., radio station 504, within its vicinity. The media device 502 may include the capability to enable a user to configure a set of favorite radio stations and/or radio station frequencies so that the user can conveniently tune the broadcast radio receiver 432 to a favorite radio station.

In addition to the radio receiver 432, the media device 502 may include a data transceiver as part of its communications circuitry 422 to facilitate the exchange of data with a PLMN, e.g., PLMN 530, a wireless access network, e.g., via AP 540, or another like wireless data network. In certain embodiments, the media device 502 may utilize a data transceiver to supplement broadcast media and/or media data received from a radio station such as radio stations 504 and 524. In one embodiment, the media device 502 is capable of querying a clearinghouse media data server 516 via a wireless data network (e.g., PLMN or wireless access network) to obtain media and/or media data. A clearinghouse server 516 may include one or more data servers and systems that perform a network-based services via, for example, the Internet. One example of a clearinghouse media data server 512 is the iTunes® music downloading service, made available by Apple Inc. of Cupertino, Calif. Media data may include metadata and/or data about or related to media. For example, media data may include an image such as album cover art related to a song. Media data may also include information related to a broadcast source of the media such as the name of a radio station playing a song. In certain embodiments, the media device 502 can retrieve media and/or media data from a radio station server 504 and/or its associated database 508, the clearinghouse server 516 and/or its associated database 518, a remote web server 552, and any other data source in communication with the network 510.

One problem with existing broadcast radio receivers is that the received broadcast signal is typically lost or its signal quality become unacceptably degraded depending on the location of the radio receiver with respect to the broadcast source. The present invention advantageously addresses this problem by enabling a media device 502 to access a data network to supplement and/or replace the broadcast signal with a network signal including the media.

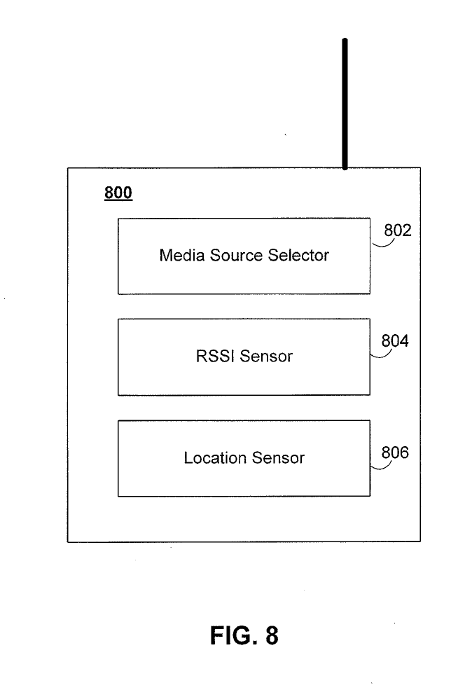

FIG. 8 is a diagram of a computer processing environment including various applications or routines running within a media device 800 according to an illustrative embodiment of the invention. The media device 800 includes a media source selector function 802, a received signal strength sensor function 804, and a location function 806. The media source selector function 802 may include various hardware and/or software elements that enable the selector 802 to select the signal source to be used to output audio and/or visual media information to a user.

The selector 802 may include a data switch that receives a broadcast radio signal via interface 522 and network signal via interface 536 and then selects or switches the selected signal among the input signals to a user interface to be output to a user. The selector may include a processor, e.g., processor 402 of FIG. 4, that controls the data switch based on a selector application. The selector function 802 may select the broadcast radio signal when a signal characteristic of the broadcast radio signal satisfies a selection standard, but select the network signal when the signal characteristic does not satisfy the selection standard. The selector function 802 may determine when the signal characteristic satisfies the selection standard or does not satisfy the selection standard and controls the selection by the data switch based on the determination.

The selector 802 may interface with and/or utilize the RSSI sensor function 804 to measure the signal strength of the received broadcast signal. The selector 802 may interface with and/or utilize the location sensor to determine the location of the sensor and, thereby, identify the broadcast source such as, for example, broadcast source 504. The selector 802 may utilize the frequency of the received broadcast radio signal via the interface 522 and/or the location of the media device to identify the broadcast media source. Once identified, the selector 802 may query a media server such as media server 506, 516, and/or 522 to retrieve an address of a media server of the network 510 from which the media device 502 is able to receive the media via a network signal.

For example, if the media device 502 were in the vicinity of San Francisco, Calif., a user may program the media device 502 to receive a broadcast signal from KSAN-FM at 107.7 MHz. However, if the media device 502 is transported by the user outside of the range of the broadcast signal provided by KSAN-FM, the media device 502 may detect the loss of KSAN-FM's broadcast signal and transfer to an network signal via wireless interfaces 536 and/or 534 to receive the media from KSAN-FM via a data network media source. The media device 502 may connect to an audio feed provided by a clearinghouse media server 516 at, for example, http://www.streamaudio.com/stations/ask/ksan_fm.asx or connect to a KSAN-FM media server 506 at, for example, http://www.1077thebone.com/. The media device 502 may query a media information server (e.g., sever 506, 512, 516, and/or 552) to retrieve the URL and/or other network address information. The media information server 552 may include an Internet radio information site such as, without limitation, the radio-locator list at www.radio-locator.com.

Alternatively, the media device 502 may have an internal data store and/or database, e.g., database 900, that includes a listing of media severs for broadcast sources, e.g. broadcast source 504, and their associated network addresses which allows to media device 502 to establish a data connection with a media server without the need for requesting an address of the media server from another media server. Thus, in certain embodiments, the media device 502 is able to provide a continuous output of the media via a user interface from a network signal including the media even when the broadcast signal including the media becomes unavailable or unusable.

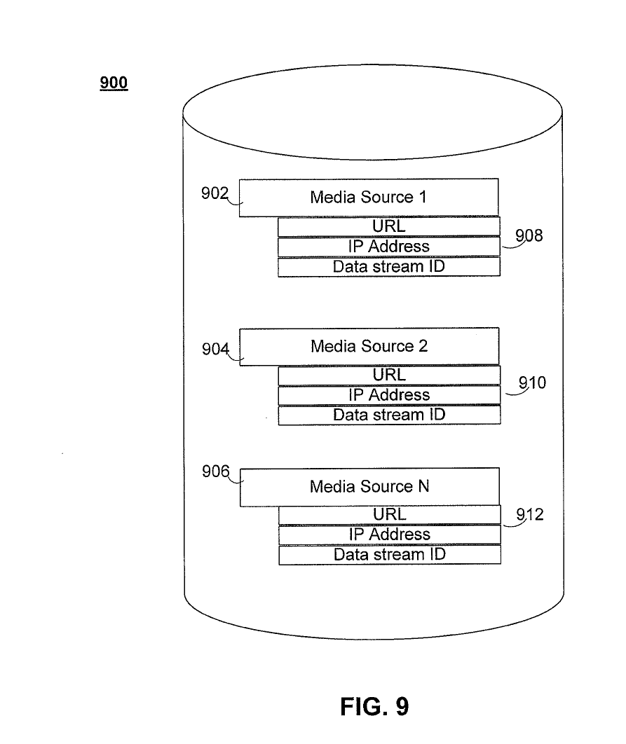

FIG. 9 includes a database 900 and/or list associating media sources 902, 904, and 906 with enhanced media sever address data 908, 910, and 912 respectively according to an illustrative embodiment of the invention. The database 900 may be located at a media server such as a broadcast media server or a clearinghouse media server. The database 900 may be located within a media device itself. Once the media device 502 identifies the broadcast source of the media being provided via the interface 522, the media device 502 may query the database 900 to identify a media server and its associated address information to enable the media device to receive the media via the interface 536 and/or interface 534 using a data network connection.

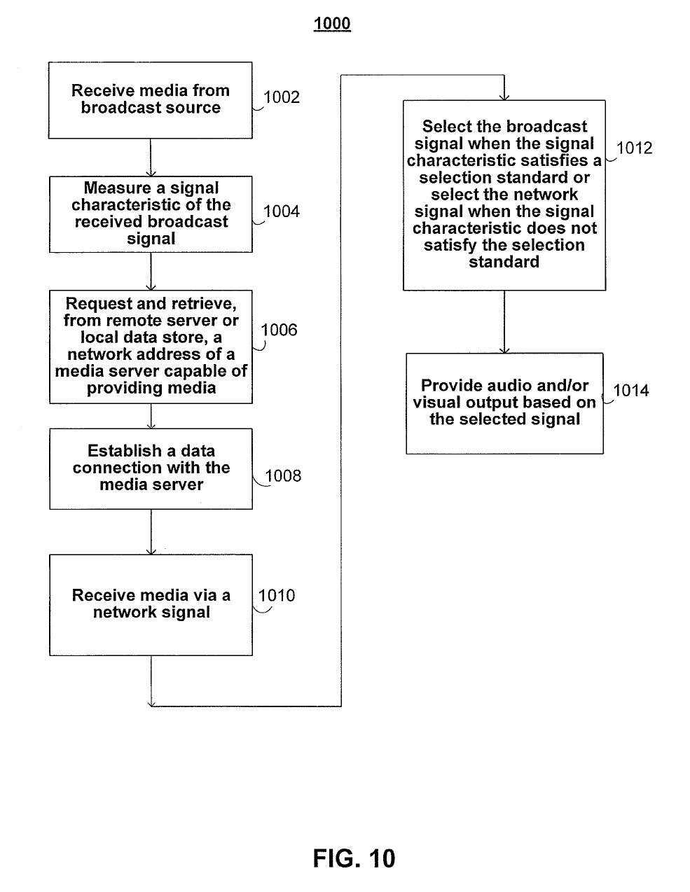

FIG. 10 is a flow diagram of a process 1000 for distributing media according to an illustrative embodiment of the invention. First, a media device 502 receives media from a broadcast source, e.g., source 504, via a broadcast radio signal over interface 522 (Step 1002). Then, the media device 502 measures a signal characteristic of the received broadcast radio signal (Step 1004). The media device 502 requests and retrieves a network address of a media server, e.g., media server 506, capable of providing the media via a network signal from a data network 510. Alternatively, the media device 502 requests and retrieves a network address from a data store 900 of the media device itself (Step 1006).

The media device 502 then establishes a data connection with the media server 506 (Step 1008). The media device 502 receives the media via the network signal from the media server 506 over the interface 536 and/or 534 (Step 1010). The media device 502 selects the broadcast radio signal when the signal characteristic satisfies a selection standard or selects the network signal when the signal characteristic does not satisfy the selection standard (Step 1012). The media device then provides an audio and/or visual output based on the selected signal (Step 1014).

Persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof which are within the spirit of the following claims.

What is claimed is:

1. A media device comprising:
a broadcast receiver for receiving media from a broadcast source via a broadcast radio signal;
a radio signal sensor for measuring a signal characteristic of the received broadcast radio signal;
a data transceiver for i) requesting and retrieving a network address of a media server providing the media via a network signal from a data network, ii) establishing a data connection with the media server, and
iii) receiving the media via the network signal from the media server; and
a selector for i) selecting the broadcast radio signal when the signal characteristic satisfies a selection standard and ii) selecting the network signal when the signal characteristic does not satisfy the selection standard; and
a user interface for providing at least one of an audio and visual output based on the selected signal.

2. The device of claim 1, wherein the broadcast radio signal includes at least one of a FM and AM radio signal.

3. The device of claim 1, wherein the media includes at least one of a song and music.

4. The device of claim 1, wherein radio signal sensor includes a received signal strength sensor.

5. The device of claim 4, wherein the signal characteristic includes the received strength of the broadcast radio signal.

6. The device of claim 5, wherein the selection standard includes a signal strength threshold level.

7. The device of claim 6, wherein the selection standard is satisfied when the received signal strength of the broadcast radio signal is equal to or greater than the threshold level.

8. The device of claim 1, wherein the network address includes at least one of an IP address, a URL, a sequence number, and a data stream identifier.

9. The device of claim 8, wherein the data network includes the Internet.

10. The device of claim 1, wherein the media server includes at least one of a broadcast source server and a clearinghouse server.

11. A method for receiving media at a media device comprising:
receiving media from a broadcast source via a broadcast radio signal;
measuring a signal characteristic of the received broadcast radio signal;
requesting and retrieving a network address of a media server providing the media via a network signal from a data network;
establishing a data connection with the media server;
receiving the media via the network signal from the media server;
selecting the broadcast radio signal when the signal characteristic satisfies a selection standard;
selecting the network signal when the signal characteristic does not satisfy the selection standard; and
providing at least one of an audio and visual output based on the selected signal.

12. The method of claim 11, wherein the broadcast radio signal includes at least one of a FM and AM radio signal.

13. The method of claim 11, wherein the media includes at least one of a song and music.

14. The method of claim 11, wherein the measuring is performed by a radio signal sensor, the radio signal sensor including a received signal strength sensor.

15. The method of claim 11, wherein the signal characteristic includes a received strength of the broadcast radio signal.

16. The method of claim 15, wherein the selection standard includes a signal strength threshold level.

17. The method of claim 16, wherein the selection standard is satisfied when the received signal strength of the broadcast radio signal is equal to or greater than the threshold level.

18. The method of claim 11, wherein the network address includes at least one of an IP address, a URL, a sequence number, and a data stream identifier.

19. The method of claim 18, wherein the data network includes the Internet.

20. The method of claim 11, wherein the media server includes at least one of a broadcast source server and a clearinghouse server.

21. A computer-readable medium that stores instructions executable by a media device to cause the media device to perform a method for receiving media, the method comprising:
receiving media from a broadcast source via a broadcast radio signal;
measuring a signal characteristic of the received broadcast radio signal;
storing a list of data network addresses associated with a plurality of media servers in a data store of the media device, at least one network address being associated with at least one media server, the at least one media server being operable to provide the media via a network signal from a data network;
retrieving the at least one network address of the at least one media server from the data store;
establishing a data connection with the at least one media server;
receiving the media via the network signal from the at least one media server;
selecting the broadcast radio signal when the signal characteristic satisfies a selection standard;
selecting the network signal when the signal characteristic does not satisfy the selection standard; and
providing at least one of an audio and visual output based on the selected signal.

22. The method of claim 21, wherein the broadcast radio signal includes at least one of a FM and AM radio signal.

23. The method of claim 21, wherein the media includes at least one of a song and music.

24. The method of claim 21, wherein the measuring is performed by a radio signal sensor, the radio signal sensor including a received signal strength sensor.

25. The method of claim 21, wherein the signal characteristic includes a received strength of the broadcast radio signal.

26. A media device comprising:
a broadcast receiver for receiving media from a broadcast source via a broadcast radio signal;
a radio signal sensor for measuring a signal characteristic of the received broadcast radio signal;
a data store for storing a list of data network addresses associated with a plurality of media servers, at least one network address being associated with at least one media server, the at least one media server being operable to provide the media via a network signal from a data network;
a data transceiver for i) establishing a data connection with the at least one media server, and
ii) receiving the media via the network signal from the at least one media server; and
a selector for i) selecting the broadcast radio signal when the signal characteristic satisfies a selection standard and ii) selecting the network signal when the signal characteristic does not satisfy the selection standard; and
a user interface for providing at least one of an audio and visual output based on the selected signal.

27. The device of claim 26, wherein the broadcast radio signal includes at least one of a FM and AM radio signal.

28. The device of claim 26, wherein the media includes at least one of a song and music.

29. A media distribution server comprising:
a first interface for receiving media from a broadcast source via a first network signal of a data network, the media being associated with a broadcast radio signal;
a second interface for i) receiving a request from a media device to receive the media; and ii) providing the media to the media device via a second network signal;
wherein the request from the media device is in response to a signal characteristic of the broadcast radio signal of the media received by the media device.

30. The server of claim 29, wherein the server includes at least one of a broadcast source server and a clearinghouse server.
